(19) United States
(12) Patent Application Publication
(10) Pub. No.: US 2011/0087400 A1
(43) Pub. Date: Apr. 14, 2011

(54) METHOD AND DEVICE FOR DIAGNOSING A CONTROL SYSTEM USING A DYNAMIC MODEL

(75) Inventor: Lionel Lorimier, Montigny Le Bretonneux (FR)

(73) Assignee: RENAULT S.A.S., Boulogne-Billancourt (FR)

(21) Appl. No.: 12/920,225

(22) PCT Filed: Feb. 23, 2009
(86) PCT No.: PCT/FR09/50283

§ 371 Date: Jan. 3, 2011

(30) Foreign Application Priority Data
Feb. 29, 2008 (FR) 0851329

(51) Int. Cl. G06F 7/00

(52) U.S. Cl. 701/35

(57) ABSTRACT

A system for diagnosing operation of a control system of at least one automobile driving parameter using a dynamic model, which includes a mechanism that stores on a non-volatile memory the input and output data of the system during the operation, adapted to store the data at a sampling frequency lower than the system sampling frequency, and including a dynamic model that can be stimulated by the stored input data to determine the reconstituted output data, and a comparison mechanism that compares the reconstituted output data with the stored output data for consistency diagnosis.

The present invention relates to the diagnosis of the operation of a system for controlling at least one driving parameter of a motor vehicle using a dynamic model.

In order to improve active safety and driving enjoyment, certain motor vehicles are equipped with driving aid devices such as antiskid systems, automatic braking systems, wheel deflection systems, etc. Such systems are operated by control laws activated by a supervisor according to operational responses meeting a certain number of conditions. The control laws are embedded in a computer onboard the vehicle and periodically generate, at a certain sampling frequency, control signals called requests, intended for actuators acting on certain members of the vehicle. In the case of an active rear wheel deflection system in a vehicle comprising at least three steerable wheels, the computer will emit rear wheel steering system deflection requests.

In order to be able to undertake the diagnosis of such systems, within the framework of an after-sales service or in the event of an accident, a certain amount of information is recorded in a nonvolatile memory which can be utilized subsequently. In the majority of cases, and because of insufficient size of the available memory, the recording of the data is sub-sampled, that is to say carried out with a lower sampling frequency than the sampling frequency producing the control requests during system operation. The recorded data being processed by computers, has a certain accuracy which must furthermore be taken into account when wishing to perform a diagnosis.

Japanese patent application JP 2000/181 742 (Fujitsu) describes a device making it possible to perform on-line fault diagnosis in a redundant system. Data reconstruction is performed as a function of the result of the diagnosis.

Patent application US 2004/122 639 (Bosch) describes a procedure for acquiring driving parameters of a motor vehicle using a three-dimensional model of the kinematics of the vehicle, so as subsequently to reconstruct the motion of the vehicle on the basis of the measurement signals representative of the lateral and longitudinal dynamics. The model used is a kinematic model.

The object of the present invention is to allow a diagnosis for control of driving parameters or requests produced by way of a control law represented by a dynamic model, that is to say a model in which the output signals are defined by differential algebraic equations as a function of the inputs.

The object of the present invention is also to propose means for the initialization of a dynamic model, used to reconstruct signals on the basis of recorded data with a view to performing a diagnosis.

According to a general aspect, there is proposed a method for diagnosing the operation of a system for controlling a driving parameter of a motor vehicle, using a dynamic model, the diagnosis being made on the basis of system input and output data which have been recorded during operation according to a certain sampling frequency. The method comprises the following steps: recording system input and output data with a lower sampling frequency than the system sampling frequency; stimulating the dynamic model with the recorded input data so as to determine reconstituted output data; comparing the reconstituted output data with the recorded output data with a view to a consistency diagnosis.

Having regard to the sampling frequency used during recording, the method preferably comprises a prior step of interpolating the data recorded at the system sampling interval.

Advantageously, a step of reconstituting the parameters and coefficients for static correction on the basis of recorded input data is undertaken thereafter.

The comparison step is done for example by comparing the discrepancy between the reconstituted data and the recorded data with a threshold value for each datum. From this is deduced an alert information item if said discrepancy is greater than the threshold value.

To be able to correctly reconstitute the output data with the aid of the dynamic model, it is important to accurately know the initial state of the system at the moment when the recording of the data is activated.

For this purpose, the method preferably comprises, before the step of stimulating the dynamic model, a step of reconstructing the initial state vector on the basis of recorded input and output data.

Generally, the dynamic model uses, for each sampling interval, discretized dynamic equations involving state variables of the model. The step of reconstructing the initial state vector is then performed by inverting a system of equations comprising recorded initial data and aforementioned dynamic equations corresponding to a minimum number of sampling intervals, on the basis of the initial state.

According to another aspect, there is also proposed a system for diagnosing the operation of a system for controlling a driving parameter of a motor vehicle, using a dynamic model, comprising means for recording on a nonvolatile memory, input and output data of the system during operation. The recording means are designed to record said data with a lower sampling frequency than the system sampling frequency.

The system comprises a dynamic model capable of being stimulated with the recorded input data so as to determine reconstituted output data. Comparison means are also designed for comparing reconstituted output data with the recorded output data with a view to a consistency diagnosis.

Preferably, the dynamic model comprises discretized dynamic equations involving, for each sampling interval, state variables of the model. The system comprises means for reconstructing the initial state vector by inverting a system of equations comprising recorded initial data and the aforementioned dynamic equations corresponding to a minimum number of sampling intervals from the initial state.

The manner in which it is possible to reconstruct an initial state vector on the basis of input and output data recorded with a minimum number of sampling intervals will now be explained more precisely.

The input vector may be defined in the form:

$$U [ k ] = [ \begin{matrix}{U}_{1} [ k ] \\ ⋮ \\ {U}_{j} [ k ]\end{matrix} ] \qquad ( 1 )$$

Each of the components of this input vector from 1 to j corresponds to a sampling instant denoted k during the sampling period Tₑ during which the recording is activated.

The m output data to which the diagnosis must pertain may be expressed by an output vector Y in the form:

$$Y [ k ] = [ \begin{matrix}{Y}_{1} [ k ] \\ ⋮ \\ {Y}_{m} [ k ]\end{matrix} ] \qquad ( 2 )$$

Finally, the state relating to the system of dimension n, which represents the output values on the basis of input data entering into the dynamic model, is expressed in the form:

$$X [ k ] = [ \begin{matrix}{X}_{1} [ k ] \\ ⋮ \\ {X}_{n} [ k ]\end{matrix} ] \qquad ( 3 )$$

The dynamic model uses, for each sampling interval, discretized dynamic equations, in the form:

$$\{ \begin{matrix}X [ k + 1 ] = {A}_{k} \cdot X [ k ] + {B}_{k} ( U [ k ] ) \\ X [ 0 ]\end{matrix} \qquad ( 4 )$$

where k is positive or zero, and where Aₖ and Bₖ are parameters expressed in matrix form.

It follows from the form of equations (4) above, that the evolution of the output values arising from the dynamic model is linear with respect to itself as shown by the first term of the matrix product Aₖ.X[k]. On the other hand, the evolution may be non-linear with respect to the input data, as expressed by the second relation in the form of the matrix product Bₖ(U[k]).

The output vector Y depends linearly on the state X and possibly, in a non-linear manner, on the input data U according to the relation:

Y[k]=Cₖ·X[k]+Dₖ(U[k]) (5)

where Cₖ and Dₖ are parameters expressed in matrix form.

At the initial instant which corresponds to k=0, the input data U[0] and the output data Y[0] are known since they have formed the subject of a recording in the nonvolatile memory of the system.

Equation (4) comprises n unknowns (X(0)) and m equations in the form:

Y[0]=C₀.X[0]₊D₀(U[0]) (6)

By assuming that all the relations are quite independent, it is therefore possible to construct a system of m equations. If m is greater than or equal to n, and if the matrix C₀ is invertible, the equation system obtained makes it possible to determine X[0]. In the converse case, it is necessary to use the relations existing at the next sampling instant for which k=1, to obtain more equations. The inputs U[1] and the outputs Y[1] are then introduced and the relations represented by equations (4) and (5) above are used at the sampling interval k=1.

It follows from this that the vector of unknowns is supplemented with the unknowns X(1), and the system of equations is supplemented with the equations

X[1]=A₀.X[0]₊B₀(U[0]) (7)

and

Y[1]=C₁.X[1]₊D₁(U[1]) (8).

In a general way, we therefore have 2.n unknowns for 2.m+n equations, on condition of course that the relations are indeed independent. If the equation system is invertible, the vector X[0] is then obtained by matrix inversion.

In the converse case, it is necessary to repeat the process again. The next sampling instant is then considered, for k=2 at the instant 2.Tₑ. This leads to a vector of 3.n unknowns in the form:

$$[ \begin{matrix}X [ 0 ] \\ X [ 1 ] \\ X [ 2 ]\end{matrix} ] \qquad ( 9 )$$

with furthermore 3.m+2.n equations.

If the iteration is continued further up to the instant k=p at the instant p.T, a vector of p.n unknowns is obtained in the form:

$$[ \begin{matrix}X [ 0 ] \\ ⋮ \\ X [ p ]\end{matrix} ] \qquad ( 10 )$$

with (p+1).m+p.n equations.

The iterations are continued until more equations than unknowns are obtained. By retaining only the number of equations necessary for inverting the system of equations, the initial state X[0] is then obtained through the matrix equation:

$$[ \begin{matrix}{C}_{0} & 0 & ⋯ & 0 & 0 \\ - {A}_{0} & I & 0 & ⋯ & 0 \\ 0 & {C}_{1} & 0 & ⋯ & ⋮ \\ ⋮ & & & ⋱ & 0 \\ & & 0 & - {A}_{p - 1} & I \\ 0 & 0 & ⋯ & 0 & {C}_{p}\end{matrix} ] \cdot [ \begin{matrix}X [ 0 ] \\ X [ 1 ] \\ ⋮ \\ X [ p ]\end{matrix} ] = [ \begin{matrix}Y [ 0 ] - {D}_{0} ( U [ 0 ] ) \\ {B}_{0} ( U [ 0 ] ) \\ ⋮ \\ \\ {B}_{p - 1} ( U [ p - 1 ] ) \\ Y [ p ] - {D}_{p} ( U [ p ] )\end{matrix} ] \qquad ( 11 )$$

where I is the unit matrix.

The value of p corresponds to the integer value immediately greater than the ratio (n/m)−1.

According to an advantageous exemplary implementation, the driving parameter which forms the subject of the diagnosis may be a deflection request for a rear wheel of a vehicle comprising at least three steerable wheels. The recorded initial data used in the aforementioned system of equations can then comprise the longitudinal speed of the vehicle, the angle of deflection of the front wheels, the dynamic part of the rear wheel deflection angle, the static part of the rear wheel deflection angle and the setpoint value of the rear wheel deflection angle. The aforementioned dynamic equations comprise as unknowns, the modeled value of the rear wheel deflection angle, the yaw rate, the lateral drift and an intermediate value of positive feedback of the rear wheel deflection angle. If these are supplemented with the setpoint value of the rear wheel deflection angle, then there are four states. The setpoint value of the rear wheel deflection angle is however entirely determined by the knowledge of the input and output at the instant k.

It suffices in this case to take into account the above equations for four recorded sampling intervals, that is to say up to the sampling instant 3.Te (from 0 to p=3).

In a first application, the initial state vector allowing the initialization of the dynamic model has not been recorded. The reconstituted data used in the comparison step are then data reconstituted on the basis of a reconstructed initial state.

In a second application, the initial state vector allowing the initialization of the dynamic model has on the contrary been recorded. The method then comprises an additional step of prior verification of consistency between the initial state vector recorded and the initial state vector reconstructed by comparison with threshold values, discrepancies between the components of the recorded initial state vector and the components of the reconstructed initial state vector.

If the prior verification of consistency shows a consistency, the step of stimulating the dynamic model with the recorded input data, with a view to determining reconstituted output data, is performed on the basis of the recorded initial state vector.

If the prior verification of consistency shows an inconsistency, there is undertaken, on the basis of the recorded initial state vector, a first stimulation of the dynamic model with the recorded input data so as to determine first reconstituted output data and then, on the basis of the reconstructed initial state vector, a second stimulation of the dynamic model with the recorded input data so as to determine second reconstituted output data, and then the first reconstituted output data, the second reconstituted output data and the recorded output data are compared with a view to the final consistency diagnosis.

The invention will be better understood on studying a few embodiments and modes of implementation taken by way of wholly non-limiting examples, and illustrated by the appended drawings in which:

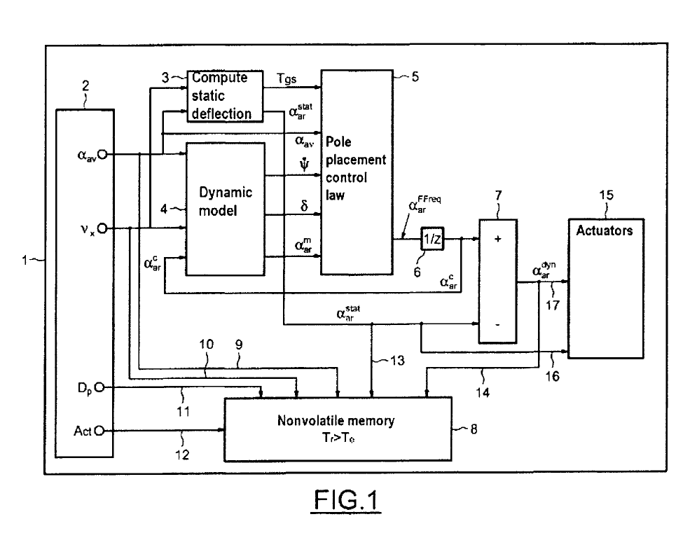

FIG. 1 illustrates by way of example the instants of recording of the data in a ratio 5 with respect to the sampling of the computations of a dynamic model used in a rear wheel deflection control system for a vehicle with at least three steerable wheels;

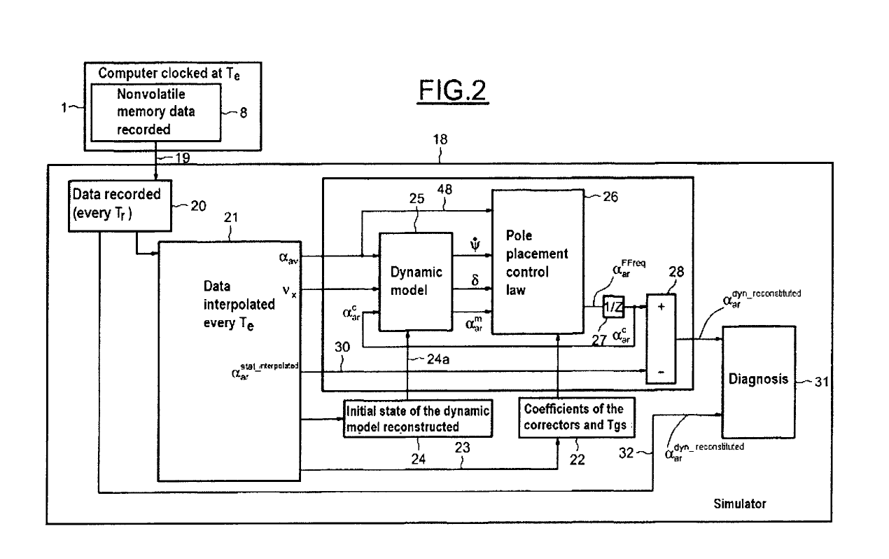

FIG. 2 schematically illustrates the main elements included in a computer comprising a dynamic model for controlling deflection of a motor vehicle rear wheel according to a first variant;

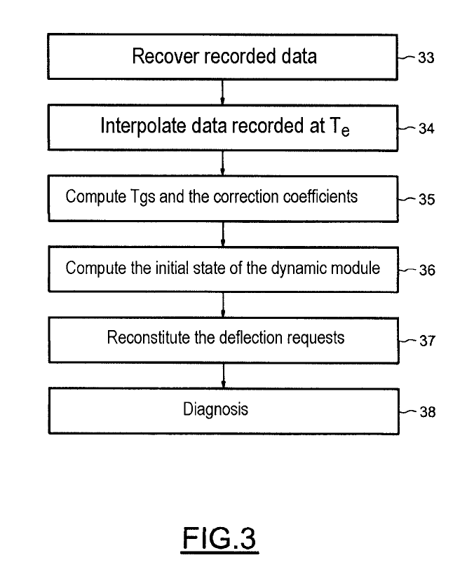

FIG. 3 illustrates the main elements of a diagnosis system making it possible to verify the operation of the control system comprising the dynamic model illustrated in FIG. 2;

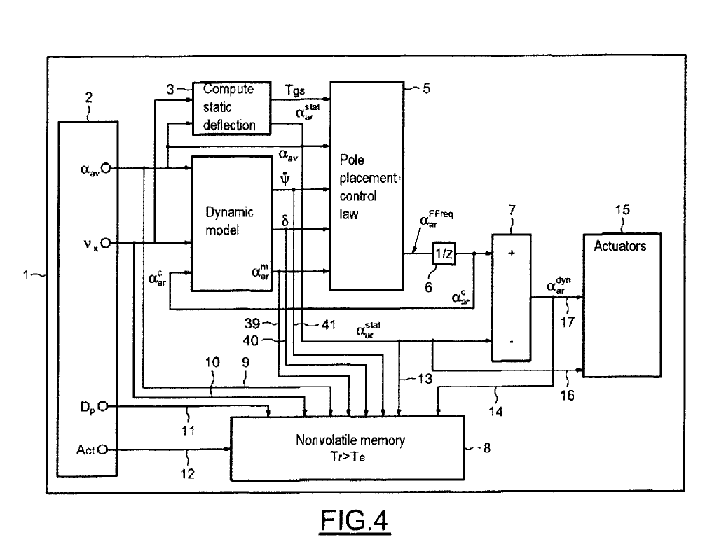

FIG. 4 illustrates the various steps of a method of diagnosis according to the invention, implemented with a system such as illustrated in FIG. 3;

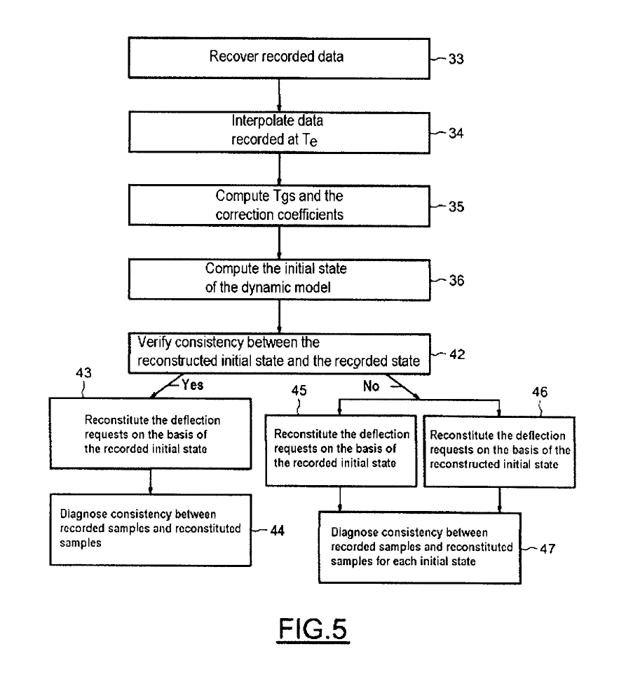

FIG. 5 illustrates a second variant of onboard computer comprising a dynamic model for the determination of control requests for the deflection of a motor vehicle rear wheel, this time with the recording of a larger number of data; and

FIG. 6 illustrates the various steps of a method of diagnosis implemented with the aid of a system such as illustrated in FIG. 3, associated with a computer such as illustrated in FIG. 5.

The various nonlimiting examples illustrated apply to a system for controlling the deflection of steerable rear wheels of a motor vehicle, such as described in particular in French patent application No. 2 864 002 (Renault) which uses a pole placement control law to determine a setpoint value of an angle of deflection of the rear wheels.

Such a control system makes it possible to generate, by means of a dynamic model, values of angle of deflection requests for at least one rear wheel, these requests being provided to an actuator device capable of performing the required deflection of the rear wheels. The system comprises a dynamic model making it possible in particular to model the lateral dynamics of the vehicle through the evolution of a certain number of quantities of steps which characterize the motion of the vehicle in space. The system furthermore comprises a positive feedback module capable of formulating a setpoint value of rear wheel deflection angle on the basis of a control and making it possible to act on the transient response dynamics. The module also formulates a static control value.

The method for implementing such a system such as described in this patent application furthermore comprises, the selective activation or deactivation of the various modules of the system so as to take account of the various situations with which the vehicle is confronted so as to obtain, under certain situations, a setpoint value of rear wheel deflection angle which improves vehicle behavior and driving comfort.

The diagnosis system according to the invention comprises means for recording on a nonvolatile memory onboard the vehicle, a certain number of input and output data of the control system. Having regard to the limited size of the memory provided in a computer onboard a motor vehicle, the recording of these data is preferably done only at certain particular moments for which the recording of the data seems important. Such will be the case, for example, upon the triggering of an anti-slip system or of a rear wheel deflection system, these systems coming into operation when the vehicle experiences particular driving situations. Moreover, and still in order to take account of the limited size of the available memory, the recorded data will only be recorded with a lower sampling frequency than that of the control system.

FIG. 1 illustrates this feature. In the upper part of FIG. 1 has been shown the recording activation signal. At the instant t=0 the signal passes from the value 0 to the value 1. This rising edge brings about the activation of recording. The lower part of FIG. 1 shows the value Tₑ of each sampling interval of the deflection control system and shows that recording is done in a ratio of 5 with respect to the sampling of the control system. The recording interval being Tᵣ, it is seen that Tᵣ=5Tₑ. At each recording interval, the values of the input data constituted by the angle of deflection of the front wheels αₐᵥ (in radians) are recorded. This angle is measured or estimated for example on the basis of the measurement of the angle of rotation of the steering wheel of the vehicle. The longitudinal speed of the vehicle vₓ in m/s is also recorded. This speed is measured or estimated for example on the basis of the knowledge of the rotation speeds of the wheels or else on the basis of the filtered derivative of the position delivered by a vehicle geographical positioning system (GPS, trademark). In the same manner, at each sampling interval two output values are recorded, namely the static deflection request for the rear wheels αₐᵣ^{stat} (in radians) and the dynamic deflection request for the rear wheels αₐᵣ^{dyn} (in radians).

These four input and output data are recorded with a sub-sampling Tᵣ with respect to the sampling Tₑ of the computations of the deflection control system. At the instant t=0 the distance traveled Dₚ at the time t=0, that is to say at the start of the recording (in km), is furthermore recorded, by way of additional input datum. This signal arises from the counter of kilometers traveled from the start of the life of the vehicle.

Reference will now be made to FIG. 2 which schematically shows the main members of a computer onboard a motor vehicle and capable of ensuring rear wheel deflection control, as indicated for example in French patent application No. 2 864 002. In FIG. 2, the computer, referenced 1 as a whole, comprises an input block 2 which receives at each sampling interval, at the sampling frequency Tₑ, the measured values of the angle of deflection of the front wheels αₐᵥ and of the longitudinal speed of the vehicle vₓ. A static deflection computation block 3 receives on its two inputs, the measured values of the angle of deflection of the front wheels αₐᵥ and of the longitudinal speed of the vehicle vₓ arising from the input block 2. The block delivers the static gain rate T_{gs} which is an adjustment parameter dependent on the speed of the vehicle and on the angle of deflection of the front wheels. This parameter is defined during the fine-tuning of the vehicle. The block 3 also delivers a static deflection request signal for the rear wheels αₐᵣ^{stat}. This value is, for example, computed on the basis of the angle of deflection of the front wheels and of the static gain rate through the formula:

αₐᵣ^{stat}=(1−Tgs(αₐᵥ,vₓ)).αₐᵥ (12)

The computer 1 also comprises a computation block 4 which comprises two models which are not identified in a precise manner in the figure and which are, one a model of the lateral dynamics of the vehicle and the other a model of the dynamics of the actuator for deflecting the rear wheels.

The model of the lateral dynamics of the vehicle takes account of the evolution of the state quantities, namely the yaw rate \dot{ψ} and the lateral drift of the vehicle δ. The differential equations which describe the evolution of these variables can be digitized according to the Euler procedure so as to obtain a linear model described by the following difference equations:

$$\begin{matrix}δ [ k + 1 ] = \frac{{T}_{e} \cdot {D}_{av}}{M \cdot {v}_{x} [ k ]} {α}_{av} [ k ] + \frac{{T}_{e} \cdot {D}_{ar}}{M \cdot {v}_{x} [ k ]} \cdot {α}_{ar}^{m} [ k ] + ( 1 - \frac{{T}_{e} \cdot ( {D}_{av} + {D}_{ar} )}{M \cdot {v}_{x} [ k ]} ) \cdot δ [ k ] - {T}_{e} \cdot ( 1 + \frac{{D}_{av} \cdot {l}_{1} - {D}_{ar} \cdot {l}_{2}}{M \cdot {{v}_{x} [ k ]}^{2}} ) \cdot \dot{ψ} [ k ] & ( 13 ) \\ \dot{ψ} [ k + 1 ] = \frac{{T}_{e} \cdot {D}_{av} \cdot {l}_{1}}{{I}_{zz}} \cdot {α}_{av} [ k ] - \frac{{T}_{e} \cdot {D}_{ar} \cdot {l}_{2}}{{I}_{zz}} \cdot {α}_{ar}^{m} [ k ] + {T}_{e} \cdot \frac{( {D}_{ar} \cdot {l}_{2} - {D}_{av} \cdot {l}_{1} )}{{I}_{zz}} \cdot δ [ k ] + ( 1 + {T}_{e} \cdot \frac{{D}_{av} \cdot {l}_{1}^{2} + {D}_{ar} \cdot {l}_{2}^{2}}{{I}_{zz} \cdot {v}_{x} [ k ]} ) \cdot \dot{ψ} [ k ] & ( 14 )\end{matrix}$$

With k≧0 the k^{th} sampling instant,

Dₐᵥ the drift rigidity of the front axle set (N/rad),

Dₐᵣ that of the rear axle set (N/rad),

I_{zz} the rotational inertia of the vehicle about its yaw axis (upward vertical) (kg.m²),

M the mass of the vehicle (in kg),

l₁ the distance between the center of gravity and the axis of the front axle set (m),

l₂ the distance between the center of gravity and the axis of the rear axle set (m),

and L=l₁+l₂ the wheelbase of the vehicle.

The model of the dynamics of the actuator for deflecting the rear wheels gives an estimation of the evolution of the deflection of the rear wheels as a function of the deflection setpoints. This model is also described by a difference equation resulting from the digitization of the differential equation characterizing a first-order dynamics of the actuator according to the Euler procedure:

$${α}_{ar}^{m} [ k + 1 ] = ( 1 - \frac{{T}_{e}}{τ} ) \cdot {α}_{ar}^{m} [ k ] + \frac{{T}_{e}}{τ} \cdot {α}_{ar}^{c} [ k ] \qquad ( 15 )$$

where

τ is the characteristic time constant of the first-order dynamic model,

αₐᵣ^{m} is the modeled value of the rear wheel deflection angle and,

αₐᵣ^{c} is the setpoint value of the rear wheel deflection angle.

It will be noted that at each instant we have:

αₐᵣ^{c}=αₐᵣ^{dyn}+αₐᵣ^{stat} (16)

The computer 1 furthermore comprises a block 5 allowing the computation of a pole placement control law as described for example in French patent application No. 2 864 002. This block delivers an intermediate variable αₐᵣ^{FFreq} which corresponds to a positive feedback in the system, as described in the aforementioned French patent application. This intermediate variable is obtained through the equation:

αₐᵣ^{FFreq}=[k]=−K₁[k]·\dot{ψ}[k]−K₂[k]·δ[k]−K₃[k]·αₐᵣ^{m}[k]+K[k]·αₐᵥ[k] (17)

where the coefficients of the corrector K_{1,} K₂ and K₃ are obtained as indicated in the aforementioned patent application.

The coefficient K is given by the equation:

$$K [ k ] = {K}_{1} [ k ] + Tgs [ k ] \cdot ( - {K}_{2} [ k ] \cdot ( \frac{{l}_{1}}{{v}_{x} [ k ]} + C\_DFF \cdot {v}_{x} [ k ] ) + {K}_{1} [ k ] ) \cdot \frac{{v}_{x} [ k ]}{L + C\_da \cdot {{v}_{x} [ k ]}^{2}} + ( 1 - Tgs [ k ] ) \cdot ( 1 + {K}_{3} [ k ] ) \qquad ( 18 )$$

where C_DFF and C_da are coefficients dependent on the geometric parameters and drift rigidities of the front and rear axle sets of the vehicle. In this instance,

$$C\_DFF = \frac{{l}_{2} \cdot M}{L \cdot {D}_{av}} and C\_da = M \cdot \frac{{l}_{2} \cdot {D}_{ar} - {l}_{1} \cdot {D}_{av}}{L \cdot {D}_{av} \cdot {D}_{ar}}$$

The block 6 illustrated in FIG. 2 and symbolized by the label 1/z, causes a delay of a sampling interval which is manifested by the following formula:

αₐᵣ^{c}[k+1]=αₐᵣ^{FFreq}[k] (19)

It will be noted that the setpoint value of the rear wheel deflection angle α^{c}ₐᵣ is initialized at the instant of the start of recording in an independent manner and without complying with this equation.

The block 7 is an addition block which receives on its positive input the setpoint value αₐᵣ^{c} arising from the block 5 and on its negative input, the static deflection request αₐ^{stat} arising from the block 3. The adder block 7 therefore delivers the dynamic deflection request for the rear wheels according to the formula:

αₐᵣ^{dyn}[k]=αₐᵣ^{c}[k]−αₐᵣ^{stat}[k] (20)

The computer 1 is equipped with a nonvolatile memory referenced 8 which allows the recording, as indicated previously, of the input and output data at the sampling period Tᵣ.

As indicated with reference to FIG. 1, the recording of this information commences as soon as the activation signal passes from the value 0 to the value 1. Recording stops automatically when the required number of recorded data is attained. The input data αₐᵥ and vₓ are conveyed to the memory 8 by the connections 9 and 10. The memory 8 also receives at the start of recording, the distance traveled Dₚ through the connection 11. Recording in the memory 8 starts upon receipt of the activation signal Act by way of the connection 12.

The output data consisting of the static deflection request αₐᵣ^{stat} conveyed by the connection 13 and the dynamic deflection request αₐᵣ^{dyn} conveyed by the connection 14 are also recorded, as indicated previously, according to the recording period Tᵣ greater than or equal to the sampling period Tₑ of the rear wheel deflection control strategy, so as to limit the number of recorded data.

A control block 15 receives the static deflection request αₐᵣ^{stat} through the connection 16 and the dynamic deflection request αₐᵣ^{dyn} through the connection 17 and acts directly on the actuators for the rear wheel deflection.

FIG. 3 illustrates the main members of a diagnosis system making it possible to establish a consistency diagnosis for the data recorded by the computer 1 during the operation of the rear wheel deflection system illustrated in FIG. 2. Depicted in FIG. 3 is the computer 1 comprising the nonvolatile memory 8. The data recorded in the memory 8 may be recovered in a simulator referenced 18 as a whole, by transmission means 19 of conventional type and not described here. The recovery of the recorded data which makes it possible to read the content of the nonvolatile memory 8 includes various processing operations not illustrated here, necessary to render the data readable by the simulator and possibly including, for example, decoding steps.

The data recorded in the memory 8 are therefore in an input block 20 inside the simulator 18. These data have been recorded as indicated previously, with a sampling frequency Tᵣ.

It is firstly appropriate to undertake an interpolation of the recorded data so as to reconstitute for all the inputs and outputs recorded, the value of the data at the sampling interval Tₑ. This operation is performed in the interpolation block 21.

Before undertaking the following steps, it is necessary to reconstitute the values of the parameter Tgs and of the coefficients of the correctors at each sampling interval, these coefficients of correctors having been used to compute the rear wheel deflection request. This operation is performed in the block 22 on the basis of the front wheel deflection data and of the speed of the vehicle, these data being interpolated and provided by the connection 23 arising from the block 21. This information is thus obtained for the whole of the duration of the recording and at the sampling period Tₑ.

If k=0 is the initial instant from which recording began, the state variables of the dynamic model, namely the yaw rate \dot{ψ}, the lateral drift δ and the modeled value of the rear wheel deflection angle αₐᵣ^{m} have unknown values which are not necessarily zero.

In order to be able to reconstitute the dynamic requests by stimulating a copy of the dynamic model embedded in the computer 1 with the inputs which have been recorded, it is necessary to reconstruct the initial state of the model. This reconstruction is done in the block 24 in a manner which will be explained subsequently. This reconstituted initial state is conveyed by the connection 24a to the input of a block 25 which is identical to the block 4 of the computer 1, and which comprises an identical dynamic model. The block 25 receives on its inputs the value of the interpolated data arising from the block 21 for the angle of deflection of the front wheels αₐᵥ and the longitudinal speed of the vehicle vₓ. The block 25 also receives on its input the setpoint value of the rear wheel deflection angle αₐᵣ^{c} which is computed by a block 26 corresponding to the block 5 of the computer 1 and which contains the same pole placement control law. The block 26 receives on its various inputs the values determined by the dynamic model of the block 25 constituted by the yaw rate \dot{ψ}, the lateral drift δ and the modeled value of the rear wheel deflection request αₐᵣ^{m}. The block 26 also receives through the connection 48 the interpolated value of the front wheel deflection angle αₐᵥ.

The block 26 delivers at its output the intermediate variable of positive feedback αₐᵣ^{FFreq} for the rear wheel deflection angle request which forms the subject, through the block 27, of a delay of a sampling interval so as to produce the setpoint value of rear wheel deflection angle αₐᵣ^{c} which is fed back through the connection 29 to the input of the block 25. This value is also fed to the positive input of the adder block 28, which moreover receives on its negative input, through the connection 30, the interpolated value of the static deflection request for the rear wheels αₐᵣ^{stat}^{_{—}}^{interpolated}.

Finally, at the output of the adder block 28 is obtained, as was the case at the output of the adder block 7 of the computer 1, a value of rear wheel dynamic deflection request which is this time obtained by reconstitution and which is denoted αₐᵣ^{dyn}^{_{—}}^{reconstituted}.

This reconstituted value, which has been obtained by interpolation in the block 21 of the data recorded in the memory 8 of the computer 1, is compared, in a comparison and diagnosis block 31 with the corresponding recorded value of the dynamic deflection request αₐᵣ^{dyn}^{_{—}}^{recorded} which is conveyed through the connection 32 arising from the block 20 up to the block 31 with a view to a consistency diagnosis.

Referring to FIG. 4, it is seen that the implementation of the system such as illustrated in FIG. 3 is done through a succession of steps. The first step 33 which is done upstream of the block 20 illustrated in FIG. 3, allows the recovery of the recorded data. It consists in reading the content of the nonvolatile memory 8 of the computer 1, which contains the sub-sampled recorded data.

The second step 34 which is performed in the block 21 allows the interpolation of the data recorded at the system sampling interval Tₑ. This interpolation can be done for example in a linear manner. If the sub-sampling ratio of the recording of the data is denoted by n=Tᵣ/Tₑ, the angle of deflection of the front wheels is then obtained at the instant n.k where k is a positive integer or zero, through the formula:

αₐᵥ^{interpolated}[n.k]=αₐᵥ^{recorded}[n.k] (21)

For each instant m lying between n.k and n.(k+1), it is necessary to reconstitute the recorded datum. It will for example be possible to perform a linear interpolation based on the known data, namely αₐᵥ^{recorded}[n.k] and αₐᵥ^{recorded}[n.(k+1)]. The interpolation can be done through the equation:

$${α}_{av}^{interpolated} [ n \cdot k + m ] = {α}_{av}^{recorded} [ n \cdot k ] + m * \frac{{α}_{av}^{recorded} [ n \cdot ( k + 1 ) ] - {α}_{av}^{recorded} [ n \cdot k ]}{n} \qquad ( 22 )$$

The same interpolation operation is done on all the other recorded data, under the same conditions.

The following step consists in computing the value of the parameter constituted by the static gain rate Tgs as well as the coefficients of the correctors for each sampling interval. This step is denoted 35 in FIG. 4 and it is implemented by the block 22 illustrated in FIG. 3. The reconstituted values of the corrector coefficients and for Tgs are obtained on the basis of the front wheel deflection and vehicle speed data, interpolated at the previous step.

The computation of the initial state of the dynamic model is thereafter performed in step 36 solely on the basis of the knowledge of the inputs and of the recorded outputs that formed the subject of the interpolation. Given that there are a restricted number of recorded values as regards the outputs of the model, that is to say in the example illustrated, the static and dynamic values of the rear wheel deflection angle request, it is important to use the minimum of points to reconstitute the initial state. If too large a number of points is used, the final diagnosis risks being falsified. Indeed, the diagnosis is based on the interpretation of the discrepancies noted between the simulated outputs reconstituted on the basis of the likewise reconstructed initial state, and the recorded outputs. The fact of using too many recorded samples for the output data would cause a decrease in the potential discrepancy because of the fact that this would no longer be the real initial state of the model at the instant of the recording on the vehicle which would be reconstructed, but a fictitious state different from this real state.

It was seen above that it was possible to reconstruct the initial state in a general way on the basis of a minimum number of equations so as to render invertible a system of equations obtained on the basis of the output data computed using the recorded inputs. In the example illustrated, one proceeds in the following manner.

At the start of the recording of the data, as indicated in FIG. 1, the recorded inputs vₓ[0] and αₐᵥ[0] are available together with the recorded output αₐᵣ^{dyn}[0], which is the dynamic rear wheel deflection angle request. The recorded output constituted by αₐᵣ^{stat}[0], that is to say the rear wheel static deflection request, is also known.

The state variables of the dynamic model which constitute the inputs of the block 26 in FIG. 3, are on the other hand unknown. These are the modeled value of the rear wheel deflection angle αₐᵣ^{m}[0], of the yaw rate \dot{ψ}[0] and of the lateral drift δ[0]. The same holds for the intermediate variable of positive feedback αₐᵣ^{FFreq}[0]. At this juncture, we therefore have an equation of the form of equation (17) above for four unknowns. It is therefore impossible to precisely determine the state of the model αₐᵣ^{m}[0], \dot{ψ}[0], δ[0].

In order to get further equations, the information relating to the next computation instant is used. The input data vₓ[1], αₐᵥ[1], the output datum αₐᵣ^{dyn}[1] and also the output datum αₐᵣ^{stat}[1] are known. From this, the intermediate variable αₐᵣ^{c}[1] can readily be deduced, through an equation of the type of equation (20). Equations (13), (14), (15), (17) and (19) afford five new equations with four new unknowns, namely αₐᵣ^{m}[1], \dot{ψ}[1], δ[1], α_{qr}^{FFreq}[1], i.e. an aggregate total of six equations for eight unknowns, thus remaining insufficient to determine the initial state since this constitutes an indeterminate system of equations.

The information will then be taken at the computation instant T₂ which provides five new equations and four new unknowns, namely, αₐᵣ^{m}[2], \dot{ψ}[2], δ[2], αₐᵣ^{FFreq}[2], i.e. an aggregate total of eleven equations and twelve unknowns.

The use of output and input data at the instant T₃ adds a new equation by combining equations (19) and (20) without adding any new unknown since it makes it possible to determine α_{aqr}^{FFreq}[2].

At this juncture the equation system is therefore invertible, and makes it possible to determine all the unknowns, and ultimately the initial state of the dynamic model, namely αₐᵣ^{m}[0], \dot{ψ}[0], δ[0].

Combining the various equations mentioned above gives the system:

$$[ \begin{matrix}{K}_{1} [ 0 ] & {K}_{2} [ 0 ] & K 3 [ 0 ] & 0 & 0 & 0 & 0 & 0 & 0 \\ 0 & 0 & \frac{{T}_{e}}{τ} - 1 & 0 & 0 & 1 & 0 & 0 & 0 \\ - {a}_{11} & - {a}_{12} & - {a}_{13} & 0 & 1 & 0 & 0 & 0 & 0 \\ - {a}_{21} & - {a}_{22} & - {a}_{23} & 1 & 0 & 0 & 0 & 0 & 0 \\ 0 & 0 & 0 & {K}_{1} [ 1 ] & {K}_{2} [ 1 ] & {K}_{3} [ 1 ] & 0 & 0 & 0 \\ 0 & 0 & 0 & 0 & 0 & \frac{{T}_{e}}{τ} - 1 & 0 & 0 & 1 \\ 0 & 0 & 0 & - {b}_{11} & - {b}_{12} & - {b}_{13} & 0 & 1 & 0 \\ 0 & 0 & 0 & - {b}_{21} & - {b}_{22} & - {b}_{23} & 1 & 0 & 0 \\ 0 & 0 & 0 & 0 & 0 & 0 & {K}_{1} [ 2 ] & {K}_{2} [ 2 ] & {K}_{3} [ 2 ]\end{matrix} ] \cdot [ \begin{matrix}\dot{ψ} [ 0 ] \\ δ [ 0 ] \\ {α}_{ar}^{m} [ 0 ] \\ \dot{ψ} [ 1 ] \\ δ [ 1 ] \\ {α}_{ar}^{m} [ 1 ] \\ \dot{ψ} [ 2 ] \\ δ [ 2 ] \\ {α}_{ar}^{m} [ 2 ]\end{matrix} ] = M \qquad ( 23 )$$

In this system, the intermediate variables, including the values of the intermediate variable αₐᵣ^{FFreq} at the computation instants 0, 1 and 2, have been eliminated.

The matrix M contains the data interpolated at each sampling interval Tₑ and may be written:

$$M = [ \begin{matrix}K [ 0 ] \cdot {α}_{av} [ 0 ] - {α}_{ar}^{dyn} [ 1 ] - {α}_{ar}^{stat} [ 1 ] \\ \frac{{T}_{e}}{τ} \cdot ( {α}_{ar}^{dyn} [ 0 ] + {α}_{ar}^{stat} [ 0 ] ) \\ \frac{{T}_{e} \cdot {D}_{av}}{M \cdot {v}_{x} [ 0 ]} \cdot {α}_{av} [ 0 ] \\ \frac{{T}_{e} \cdot {D}_{av} \cdot {l}_{1}}{{I}_{ZZ}} \cdot {α}_{av} [ 0 ] \\ K [ 1 ] \cdot {α}_{av} [ 1 ] - {α}_{ar}^{dyn} [ 2 ] - {α}_{ar}^{stat} [ 2 ] \\ \frac{{T}_{e}}{τ} \cdot ( {α}_{ar}^{dyn} [ 1 ] + {α}_{ar}^{stat} [ 1 ] ) \\ \frac{{T}_{e} \cdot {D}_{av}}{M \cdot {v}_{x} [ 1 ]} \cdot {α}_{av} [ 1 ] \\ \frac{{T}_{e} \cdot {D}_{av} \cdot {l}_{1}}{{I}_{ZZ}} \cdot {α}_{av} [ 1 ] \\ K [ 2 ] \cdot {α}_{av} [ 2 ] - {α}_{ar}^{dyn} [ 3 ] - {α}_{ar}^{stat} [ 3 ]\end{matrix} ] \qquad ( 24 )$$

Moreover, for the coefficients aᵢⱼ we have:

$${a}_{11} = - {T}_{e} \cdot ( 1 + \frac{{D}_{av} \cdot {l}_{1} - {D}_{ar} \cdot {l}_{2}}{M \cdot {{v}_{x} [ 0 ]}^{2}} )$$

$${a}_{12} = ( 1 - \frac{{T}_{2} \cdot ( {D}_{av} + {D}_{ar} )}{M \cdot {v}_{x} [ 0 ]} )$$

$${a}_{13} = \frac{{T}_{e} \cdot {D}_{ar}}{M \cdot {v}_{x} [ 0 ]}$$

$${a}_{21} = ( 1 - {T}_{e} \cdot \frac{{D}_{av} \cdot {l}_{1}^{2} + {D}_{ar} \cdot {l}_{2}^{2}}{{I}_{ZZ} \cdot {v}_{x} [ 0 ]} )$$

$${a}_{22} = {T}_{e} \cdot \frac{{D}_{ar} \cdot {l}_{2} - {D}_{av} \cdot {l}_{1}}{{I}_{ZZ}}$$

$${a}_{23} = \frac{{T}_{e} \cdot {D}_{ar} \cdot {l}_{2}}{M \cdot {v}_{x} [ 0 ]}$$

The coefficients bᵢⱼ are defined with the same expressions as aᵢⱼ but with vₓ[1] instead of vₓ[0].

If the 9×9 matrix of equation (23) is denoted Ainit, M being a row vector, that is to say a 9×1 matrix, the resulting row vector has dimension 3×1. The matrix Ainit is invertible and the initial state of the dynamic model can be obtained through the equation:

$$[ \begin{matrix}\dot{ψ} [ 0 ] \\ δ [ 0 ] \\ {α}_{ar}^{m} [ 0 ]\end{matrix} ] = [ \begin{matrix}1 & 0 & 0 & 0 & 0 & 0 & 0 & 0 & 0 \\ 0 & 1 & 0 & 0 & 0 & 0 & 0 & 0 & 0 \\ 0 & 0 & 1 & 0 & 0 & 0 & 0 & 0 & 0\end{matrix} ] \cdot {Ainit}^{- 1} \cdot M \qquad ( 25 )$$

After the initial state vector has been reconstituted in this way, we undertake step 37 indicated in FIG. 4, which consists in reconstituting the deflection requests in the simulator 18 of FIG. 3, the computations being performed in the various blocks 25, 26, 27 and 28. This step consists in computing, for the instants k going from 0, which corresponds to the initialization up to a time t_{recording}, the state of the dynamic model and the deflection requests produced on the basis of equations (13), (14), (15), (16), (17), (18) and (19). The value of the reconstituted dynamic deflection request for the rear wheels is ultimately obtained through the equation:

αₐᵣ^{dyn}^{_{—}}^{reconstituted}[k]=αₐᵣ^{c}[k]−αₐᵣ^{stat}^{_{—}}^{interpolated}[k] (26)

With t_{recording}≧k.Tₑ≧0,

and where k is the k^{th} sampling instant.

For these computations, use has been made of the initial state of the dynamic model reconstituted in the course of step 36 and computed in the block 24, as well as the corrector coefficients and Tgs computed for the whole recording in step 35, the computation being performed in the block 22.

The last step 38 indicated in FIG. 4 consists in performing a diagnosis by verifying the consistency of the recorded data with the reconstituted data. It will preferably be possible to plot on one and the same graph the values αₐᵣ^{dyn}[j] and αₐᵣ^{dyn}[n.k] where j and k are positive integers or zero, such that j and n.k do not exceed the number of samples available. Comparison of these values makes it possible to verify the consistency of the deflection requests at the various recording moments, as well as the general evolutionary trend over the duration of the recording.

If the discrepancy between the values αₐᵣ^{dyn}^{_{—}}^{reconstituted}[n.k] and αₐᵣ^{dyn}[n.k] where k is a positive integer or zero such that n.k does not exceed the number of samples available, exceeds a permitted threshold which takes into account the uncertainties related to the linear interpolation, to the accuracy of the data etc., a diagnosis alert message is provided so as to warn of an inconsistency between the recorded data and the reconstituted data. Such an inconsistency will make it possible to search for the cause of a malfunction of the rear wheel deflection control system onboard the vehicle.

FIG. 5 illustrates a second embodiment also applied by way of example to the diagnosis of a rear wheel deflection control system.

The identical members illustrated in FIG. 5 bear the same references as those of FIG. 2. The only difference pertains to the inputs of the nonvolatile memory 8. Indeed, in this embodiment, the current value of the signals arising from the dynamic model contained in the block 4 of the computer onboard the vehicle is also recorded at the moment of the activation of the recording (this instant being denoted k₀). These values are recorded through the connections 39, 40 and 41. The values \dot{ψ}[k₀], δ[k₀], αₐᵣ^{m}[k₀] are therefore recorded in the memory 8. These values correspond to the initial state of the dynamic model.

In this second embodiment, the method proceeds as illustrated in FIG. 6, the first four steps being identical to the first four steps of FIG. 4. In particular, in step 36, the initial state of the dynamic model is computed, as indicated previously, solely on the basis of the input and output data recorded and interpolated as previously.

A new step 42 makes it possible to perform a preliminary diagnosis by verifying firstly the consistency between the reconstructed initial state and the recorded initial state for the dynamic model. This comparison is carried out on each series of recorded data to be analyzed. To analyze this consistency, account is taken of the uncertainty related to the reconstitution of the initial state of the dynamic model in step 36, on the basis of data exhibiting certain inaccuracies related to the type of memory used, to the accuracy of the interpolation, etc. It will be estimated that the data are consistent if the following three conditions are all satisfied:

|\dot{ψ}[0]−\dot{ψ}[k₀]|<Δ\dot{ψ}ᵤ

|δ[0]−δ[k₀]|<Δδᵤ

|αᵣ^{m}[0]−αₐᵣ^{m}[k₀]|<Δαₐᵣ^{m}ᵤ (27)

where the data denoted [0] are those which have formed the subject of a reconstitution as indicated previously, while the data denoted [k₀] are those which have been recorded and where Δ\dot{ψ}ᵤ, Δδᵤ and Δαₐᵣ^{m}ᵤ are the permitted uncertainty thresholds defined during the design of the control system.

If good consistency is noted, that is to say a discrepancy of less than the threshold envisaged above, the process continues with step 43, in which the deflection requests are reconstituted by means of a simulator similar to that of FIG. 3, in which the computations are done, however, on the basis of the initial state of the dynamic model such as recorded in the memory 8.

As indicated previously, the state of the dynamic model as well as the values of the rear wheel deflection requests are computed, for the instants k going from initialization to t_{recording}, on the basis of the equations contained in the blocks 25, 26, 27 and 28, namely the previous equations (13), (14), (15), (16), (17), (18) and (19). The reconstituted rear wheel dynamic deflection request values αₐᵣ^{dyn}^{_{—}}^{reconstituted}[k] are also obtained through equation 26. However, in these various computations, the dynamic model contained in the block 25 receives as input the recorded initial state vector \dot{ψ}[k₀], δ[k₀], αₐᵣ^{m}[k₀] given that the consistency between the recorded initial state and the reconstituted initial state has been noted in the course of the previous step referenced 42 in FIG. 6.

On the basis of these reconstituted values, the diagnosis step referenced 44 in FIG. 6 is then undertaken, where the recorded values are compared with the reconstituted values. This step is done in the same manner as step 38 previously explained for the first embodiment.

In the case where an inconsistency is detected in step 42, step 45 is firstly undertaken, consisting in reconstituting the rear wheel deflection requests on the basis of the recorded initial state. A rear wheel deflection request denoted αₐᵣ^{dyn}^{_{—}}^{reconstituted}^{_{—}}¹ is obtained

Next, in the course of a step 46, the reconstitution of the rear wheel deflection requests is undertaken in the same manner, but this time on the basis of the reconstructed initial state. Another value denoted αₐᵣ^{dyn}^{_{—}}^{reconstituted}^{_{—}}² is obtained.

The process continues with step 47, in which the values obtained in the course of steps 45 and 46 are compared with the recorded values. It will for example be possible to plot on one and the same graph the values obtained αₐᵣ^{dyn}^{_{—}}^{reconstituted}^{_{—}}¹[j], αₐᵣ^{dyn}^{_{—}}^{reconstituted}^{_{—}}²[j] and the recorded values αₐᵣ^{dyn}[n.k] where j and k are positive integers or zero such that j and n.k do not exceed the number of samples available. On the basis of such a plot, the consistency of the requests is verified at each instant of recording, as is the general evolutionary trend over the recorded time span. Several cases then arise:

If the difference in absolute value between all the reconstituted data and the recorded data is less than a determined threshold, which takes into account the uncertainties related to the linear interpolation and to the accuracy of the data, it will be possible to conclude therefrom that the recorded information is globally consistent with the whole of the reconstituted information. It is then impossible to conclude as to the diagnosis, since an inconsistency has been noted in step 42 as regards the initial state, which inconsistency is no longer found when the data have been reconstructed on the basis, on the one hand, of the recorded initial state and, on the other hand, of the reconstructed initial state.

In another case, the following two conditions will exist simultaneously for a recording corresponding to a positive integer k or zero:

|αₐᵣ^{dyn}^{_{—}}^{reconstituted}^{_{—}}¹[n.k]−αₐᵣ^{dyn}[n.k]|>αₐᵣ^{gap}^{_{—}}^{permitted}

and

|αₐᵣ^{dyn}^{_{—}}^{reconstituted}^{_{—}}²[n.k]−αₐᵣ^{dyn}[n.k]|≦αₐᵣ^{gap}^{_{—}}^{permitted}

where αₐᵣ^{gap}^{_{—}}^{permitted} is a determined consistency threshold. In this case, the total reconstitution of the deflection requests on the basis of the input and output data is consistent with the recorded data. It will be deduced therefrom that the inconsistency noted in step 42 results from a problem of recording the initial state of the dynamic model or from a problem relating to the computation of the final requests.

In a third situation, it will be possible to note for a recording instant at least, denoted k (positive integer or zero), that we have simultaneously:

|αₐᵣ^{dyn}^{_{—}}^{reconstituted}^{_{—}}¹[n.k]−αₐᵣ^{dyn}[n.k]|≦αₐᵣ^{gap}^{_{—}}^{permitted}

and

|αₐᵣ^{dyn}^{_{—}}^{reconstituted}^{_{—}}²[n.k]−αₐᵣ^{dyn}[n.k]|>αₐᵣ^{gap}^{_{—}}^{permitted}

In this case, the reconstitution of the deflection requests on the basis of the input and output data and of the recorded initial state is consistent with the recorded data. The inconsistency noted in step 42 therefore results from a problem on the first two series of recorded samples which have been used to reconstitute the initial state.

In another situation, it will be noted that there exist two instants corresponding to k₁ and k₂ which are two positive integers or zero, for which we have simultaneously:

|αₐᵣ^{dyn}^{_{—}}^{reconstituted}^{_{—}}¹[n.k₁]−αₐᵣ^{dyn}[n.k₁]|>αₐᵣ^{gap}^{_{—}}^{permitted}

and

|αₐᵣ^{dyn}^{_{—}}^{reconstituted}^{_{—}}²[n.k₂]−αₐᵣ^{dyn}[n.k₂]|>αₐᵣ^{gap}^{_{—}}^{permitted}

In this case, the inconsistencies noted relate to a problem of computing the final requests.

It is thus seen, on studying these examples, that it is possible, by implementing the invention, whether in its first or its second embodiment, to obtain a diagnosis regarding the consistency of the recorded data with respect to reconstituted data and to deduce therefrom a cue regarding a possible malfunction of a device for controlling one or more driving parameters of a motor vehicle, for example a rear wheel deflection request.

1-12. (canceled)

13. A method for diagnosing operation of a system for controlling at least one driving parameter of a motor vehicle, using a dynamic model, the diagnosis being made based on system input and output data that have been recorded during operation, the method comprising:
recording system input and output data with a lower sampling frequency than a system sampling frequency;
stimulating the dynamic model with the recorded input data so as to determine reconstituted output data; and
comparing the reconstituted output data with the recorded output data with a view to a consistency diagnosis.

14. The method as claimed in claim 13, further comprising, before the recording, interpolating the data recorded at the system sampling interval.

15. The method as claimed in claim 13, further comprising, before the recording, reconstituting parameters and coefficients for static correction on the basis of recorded input data.

16. The method as claimed in claim 13, in which the comparing includes comparing a discrepancy between the reconstituted data and the recorded data with a threshold value for each datum and emitting an alert information item if the discrepancy is greater than the threshold value.

17. The method as claimed in claim 13, further comprising, before the stimulating the dynamic model, reconstructing an initial state vector on the basis of recorded input and output data.

18. The method as claimed in claim 17, in which the dynamic model uses, for each sampling interval, discretized dynamic equations involving state variables of the model, the reconstructing the initial state vector including inverting a system of equations comprising recorded initial data and dynamic equations corresponding to a minimum number of sampling intervals on the basis of the initial state.

19. The method as claimed in claim 18, in which the driving parameter that forms a subject of the diagnosis is a deflection request for a rear wheel of a vehicle comprising at least three steerable wheels, the recorded initial data used in the system of equations comprising longitudinal speed of the vehicle, angle of deflection of the front wheels, dynamic part of the rear wheel deflection angle, static part of the rear wheel deflection angle, control value of the rear wheel deflection angle, and the dynamic equations comprise, as variables, modeled value of the rear wheel deflection angle, yaw rate, lateral drift and an intermediate value of positive feedback of the rear wheel deflection angle.

20. The method as claimed in claim 18, in which the initial state vector allowing the initialization of the dynamic model has not been recorded, the reconstituted data used in the comparing being data reconstituted on the basis of a reconstructed initial state.

21. The method as claimed in claim 18, in which the initial state vector allowing the initialization of the dynamic model has been recorded, the method further comprising prior verification of consistency between the initial state vector recorded and the initial state vector reconstructed by comparison with threshold values of discrepancies between components of the recorded initial state vector and components of the reconstructed initial state vector.

22. The method as claimed in claim 21, in which: when the prior verification of consistency shows a consistency, the stimulating the dynamic model with the recorded input data with a view to determining reconstituted output data is performed on the basis of the recorded initial state vector; when the prior verification of consistency shows an inconsistency, there is undertaken, on the basis of the recorded initial state vector, a first stimulation of the dynamic model with the recorded input data so as to determine first reconstituted output data and then, on the basis of the reconstructed initial state vector, a second stimulation of the dynamic model with the recorded input data so as to determine second reconstituted output data, and then the first reconstituted output data, the second reconstituted output data, and the recorded output data are compared with a view to the consistency diagnosis.

23. A system for diagnosing operation of a system for controlling a driving parameter of a motor vehicle, using a dynamic model, comprising:
means for recording on a nonvolatile memory input and output data of the system during operation, configured to record the data with a lower sampling frequency than a system sampling frequency;
a dynamic model configured to be stimulated with the recorded input data so as to determine reconstituted output data and comparison means for comparing reconstituted output data with the recorded output data with a view to a consistency diagnosis.

24. The system as claimed in claim 23, in which the dynamic model comprises discretized dynamic equations involving, for each sampling interval, state variables of the model, the system further comprising means for reconstructing the initial state vector by inverting a system of equations comprising recorded initial data and dynamic equations corresponding to a minimum number of sampling intervals from the initial state.
